(19) United States
(12) Patent Application Publication
(10) Pub. No.: US 2025/0154753 A1
(43) Pub. Date: May 15, 2025

(54) DRAIN CLOG REMOVER

(71) Applicant: HANGZHOU GREAT STAR INDUSTRIAL CO., LTD., Hangzhou City (CN)

(72) Inventor: Jingjian LI, Hangzhou City (CN)

(21) Appl. No.: 19/020,797

(22) Filed: Jan. 14, 2025

Related U.S. Application Data
(63) Continuation-in-part of application No. PCT/CN2023/114581, filed on Aug. 24, 2023.

(30) Foreign Application Priority Data
Aug. 26, 2022 (CN) 202222286507.0
Aug. 22, 2023 (CN) 202311063884.0

(51) Int. Cl. E03C 1/302; B08B 9/045

(52) U.S. Cl. CPC E03C 1/302; B08B 9/045

(57) ABSTRACT

A drain clog remover includes: an elongate, flexible shaft-like component; a housing component defining an interior hollow cavity for housing the flexible shaft-like component; a delivery component coupled at one end thereof to the housing component, the housing component rotatable relative to the delivery component, the delivery component defining an interior channel for passage of the flexible shaft-like component therethrough, the channel in communication with the hollow cavity, wherein the housing component, when rotated, actuates the flexible shaft-like component to rotate; and a clamping assembly disposed on the delivery component, the clamping assembly having a first state and a second state, wherein in the first state, the clamping assembly clamps the flexible shaft-like component so that the flexible shaft-like component, when rotated, displaces axially; and in the second state, the clamping assembly releases the flexible shaft-like component so that the flexible shaft-like component, when rotated, does not displace axially.

### RELATED APPLICATIONS

This application is a continuation-in-part (CIP) application claiming benefit of PCT/CN2023/114581 filed on Aug. 24, 2023, which claims priorities to Chinese Patent Application No. 202222286507.0 filed on Aug. 26, 2022 and Chinese Patent Application No. 202311063884.0 filed on Aug. 22, 2023, the disclosures of which are incorporated herein in their entirety by reference.

### BACKGROUND

The present invention relates to pipe cleaners, and more particularly to a drain clog remover.

### DESCRIPTION OF THE PRIOR ART

Drain pipes are often blocked by clogs formed by hair, fibers and other debris that entangle and accumulate therein. When this happens, cleaning is necessary with drain clog removers. Among conventional drain clog removers, those of a flexible-shaft type are common. However, these flexible-shaft type drain clog removers are inconvenient to operate because their use requires coordination of both hands to simultaneously rotate and urge the flexible shaft. To overcome this, drain clog removers using a roller-actuated flexible shaft have been developed. In these products, multiple rollers are arranged around the flexible shaft to convert rotation of the flexible shaft into its axial movement. In operation, the flexible shaft can be axially moved simply by rotating it so that it comes into contact with the rollers. However, in practical use, this type of drain clog removers frequently encounters free-running rotation of the flexible shaft without causing axial movement, or binding-up of the flexible shaft, which makes it impossible to extend or retract desirably. Further, once the flexible shaft reaches a clog in a pipe, rotation without causing axial movement is instead desired to enable more efficient debris cleaning. However, after the debris is cleaned, axial movement of the flexible shaft is again desired. Therefore, in this process, it is desired to switch the flexible shaft between axial movement and free-running rotation. However, no existing drain clog removers can provide this.

Therefore, those skilled in the art are directing their effort toward developing a drain clog remover with a flexible shaft which can be conveniently switched between free-running rotation and axial movement and can be clamped without being bound up, thereby providing more efficient debris cleaning.

### SUMMARY

Conventional drain clog removers fail to allow a flexible shaft to be efficiently extended and retracted, or switched between axial movement and free-running rotation, and frequently suffer from binding-up of the flexible shaft.

In order to overcome these problems, the present invention provides a drain clog remover comprising:
an elongate, flexible shaft-like component;
a housing component defining a hollow cavity therein for housing the flexible shaft-like component;
a delivery component coupled at one end thereof to the housing component, the housing component configured to be rotatable relative to the delivery component, the delivery component defining a channel therein for passage of the flexible shaft-like component therethrough, the channel in communication with the hollow cavity, wherein the housing component, when rotated, actuates the flexible shaft-like component to rotate; and
a clamping assembly disposed on the delivery component, the clamping assembly having a first state and a second state, wherein in the first state, the clamping assembly clamps the flexible shaft-like component so that the flexible shaft-like component, when rotated, displaces axially; and in the second state, the clamping assembly releases the flexible shaft-like component so that the flexible shaft-like component, when rotated, does not displace axially.

Additionally, the clamping assembly may comprise a plurality of rolling elements arranged circumferentially around the flexible shaft-like component, wherein the plurality of rolling elements includes at least one movable rolling element, wherein in the first state, the movable rolling element is in contact with the flexible shaft-like component, and in the second state, the movable rolling element is out of contact with the flexible shaft-like component.

Additionally, the clamping assembly may further comprise a control component configured to actuate, under the action of an external force, the movable rolling element to move into or out of contact with the flexible shaft-like component.

Additionally, the delivery component may be provided on its side wall with a movable holder configured to move in a radial direction of the delivery component driven by an external force, wherein the movable rolling element is rotatably coupled to one end of the movable holder, and the other end of the movable holder is coupled to the control component.

Additionally, the control component may be pivotably coupled to the delivery component, have a cam-shaped end portion and be configured to be actuatable by an external force to pivot in a first direction so that the cam-shaped end portion actuates the movable holder to move toward the flexible shaft-like component to bring the movable rolling element into contact with the flexible shaft-like component and to pivot in a second direction so that the cam-shaped end portion releases the movable holder to allow the movable rolling element to move out of contact with the flexible shaft-like component.

Additionally, the plurality of rolling elements may further include a fixed rolling element rotatably coupled to a fixed holder fixedly coupled to the delivery component.

Additionally, a buffer may be disposed between the control component and the movable holder.

Additionally, the movable holder may be provided with a return component configured to actuate, after a force applied by the control component to the movable holder is removed, the movable holder to move to its original position.

Additionally, the control component may comprise a ring-shaped member sleeved on the delivery component at an end thereof away from the housing component, wherein the movable rolling element is rotatably coupled to the ring-shaped member, and the ring-shaped member is configured to be swingable relative to the delivery component.

Additionally, the plurality of rolling elements may further include a fixed rolling element rotatably coupled to the delivery component, and the movable rolling element may be disposed at an end of the ring-shaped member, which is actuatable by an external force to swing relative to the delivery component.

Additionally, the control component may further comprise a control member pivotably coupled to the delivery component, wherein one end of the control member is coupled to the ring-shaped member, and the control member is configured to be actuatable by an external force to pivot relative to the delivery component and thereby actuate the ring-shaped member to swing.

Additionally, the control member may be provided with a return component configured to actuate, after a force applied to the control member is removed, the control member to return to its original position.

Additionally, a thread may be provided in a side wall of the delivery component at an end thereof away from the housing component, and the control component may comprise a cylindrical component sleeved on the delivery component and engaged with the thread.

Additionally, the movable rolling element may be rotatably disposed on a slider slidably coupled to an inner wall of the delivery component.

Additionally, a surface between the slider and the delivery component is slanted with respect to an axis of the delivery component.

Additionally, the cylindrical component may be configured to actuate, when rotated relative to the delivery component, the slider to slide along an axis of the delivery component.

Additionally, an axis of rotation of each of the plurality of rolling elements may form an acute angle with a center axis of the flexible shaft-like component.

Additionally, each of the plurality of rolling elements may be inclined in a different direction with respect to the flexible shaft-like component.

Additionally, the housing component may be provided with an actuator for actuating the housing component to rotate relative to the delivery component.

Additionally, the actuator may comprise a handle eccentrically disposed with respect to a center axis of the housing component and/or a driving shaft disposed coaxially with the center axis of the housing component.

Advantageously, the flexible shaft-like component of the present invention can be conveniently switched between free-running rotation and axial movement and can be firmly clamped without being bound up, thereby providing more efficient debris cleaning.

For a full understanding of the objects, features and effects of the present application, the concept, structural details and resulting technical effects will be further described with reference to the accompanying drawings.

### BRIEF DESCRIPTION OF THE DRAWINGS

FIG. 1 is a schematic diagram showing the structure of a first embodiment.

FIG. 2 is a schematic exploded view of the first embodiment.

FIG. 3 is a right side view of FIG. 1.

FIG. 4 is a cross-sectional view taken along I-I of FIG. 3.

FIG. 5 is a schematic diagram of a clamping assembly of the first embodiment in a non-clamping state.

FIG. 6 is a schematic diagram of a control component in the non-clamping state.

FIG. 7 is a schematic diagram of the clamping assembly of the first embodiment in a clamping state.

FIG. 8 is a front view of a second embodiment.

FIG. 9 is an axonometric view of the second embodiment.

FIG. 10 is a schematic diagram showing the positioning of rolling elements of the second embodiment.

FIG. 11 is a right side view of FIG. 8.

FIG. 12 is a schematic cross-sectional view taken along II-II of FIG. 11.

FIG. 13 is a front view of a third embodiment.

FIG. 14 is a schematic diagram with a housing component having been removed.

FIG. 15 is a schematic cross-sectional view taken along III-III of FIG. 14.

FIG. 16 is a schematic exploded view of a clamping assembly of the third embodiment.

FIG. 17 is a schematic diagram of the clamping assembly in a non-clamping state.

FIG. 18 is a schematic diagram of the clamping assembly in a clamping state.

FIG. 19 is a cross-sectional view of the third embodiment.

10 drain clog remover; 11 center axis; 20 housing component; 21 hollow cavity; 23 driving shaft; 24 first shell; 25 extension; 22 handle; 30 delivery component; 31 channel; 32 second shell; 33 grip; 40 flexible shaft-like component;
100 clamping assembly; 101 movable rolling element; 101a axis of rotation; 102 fixed rolling element; 103 fixed holder; 104 control component; 105 movable holder; 106 cam-shaped end portion; 107 raised tab; 108 pivotal shaft; 109 buffer; 110 return component; 111 axis of rotation;
200 clamping assembly; 201 end of delivery component; 202 movable rolling element; 203 fixed rolling element; 203a axis of rotation; 204 ring-shaped member; 204a end portion of ring-shaped member; 205 control member; 206 pivotal shaft; 207 pocket; 208 axis of rotation; 209 return component;
300 clamping assembly; 301 movable rolling element; 302 control component; 303 slider; 304 slanted surface; 306 thread; 307 side wall.

### DETAILED DESCRIPTION

A few preferred embodiments of the present application are described below with reference to the drawings accompanying so that the techniques disclosed herein become more apparent and better understood. The present application may be embodied in many different forms, and its scope sought to be protected hereby is not limited only to the embodiments disclosed herein.

Throughout the accompanying drawings, structurally identical parts are indicated with the identical reference numerals, and structurally or functionally similar components are indicated with similar reference numerals. In the drawings, the size and thickness of each component are arbitrarily depicted, and the present application is not limited to the size or thickness of any component. For greater clarity of illustration, the thicknesses of some parts may be exaggerated somewhere in the drawings.

A drain clog remover includes an elongate, flexible shaft-like component 40, a housing component 20, a delivery component 30 and a clamping assembly. The housing component 20 defined an interior hollow cavity 21 for housing the flexible, shaft-like component 40 therein. The housing component 20 is rotatably coupled to one end of the delivery component 30 in a lengthwise direction. The delivery component 30 defines a lengthwise extending interior channel 31 in communication with the hollow cavity 21. The flexible shaft-like component 40 can extend through the channel 31 to the outside of the delivery component 30. The clamping assembly is arranged on the delivery component 30 to clamp or release the flexible shaft-like component 40. With the clamping assembly clamping the flexible shaft-like component 40 (i.e., when in a clamping state of the clamping assembly), the flexible shaft-like component 40 can be rotated by turning the housing component 20. As a result, the clamping assembly interacts with the flexible shaft-like component 40, creating an axial push force, which extends the flexible shaft-like component 40 forward (i.e., toward the outside of the delivery component 30) or retracts it back into the housing component 20. After the flexible shaft-like component 40 is released from the clamping assembly (i.e., in a non-clamping state of the clamping assembly), the flexible shaft-like component 40 can be manually pulled forward to a given deployment location. Moreover, when the housing component 20 is rotated, the flexible shaft-like component 40 is simply rotated, but will not be extended forward or retracted back into the housing component 20.

The clamping assembly includes a plurality of rolling elements, each of which can rotate about its own axis of rotation, and which are arranged circumferentially around the flexible shaft-like component 40. Preferably, the axis of rotation of each rolling element forms an acute angle with an axis of the flexible shaft-like component 40. In the clamping state of the clamping assembly, each rolling element contacts the flexible shaft-like component 40 at a different angle. When the flexible shaft-like component 40 is rotated, the rolling elements in abutment against an outer wall of the flexible shaft-like component 40 are actuated to rotate about their respective own central axes 11. As a result, the rolling elements displace relative to the flexible shaft-like component 40 along the axis thereof, thus extending the flexible shaft-like component 40 forward or retracting it back into the housing component 20. At least one of the rolling elements is movable, and a control component is provided on the clamping assembly. The control component can be manipulated to move the movable rolling element into contact with, or away from, the flexible shaft-like component 40, thereby clamping or releasing the flexible shaft-like component 40.

The drain clog remover of the present invention can clamp or release the flexible shaft-like component 40, switching the flexible shaft-like component 40 between free-running rotation and axial movement. When clamped by the clamping assembly, the flexible shaft-like component 40 can be effectively locked, allowing extension and retraction of the flexible shaft-like component 40.

The drain clog remover of the present invention will be described in detail below by way of several examples.

### Example 1

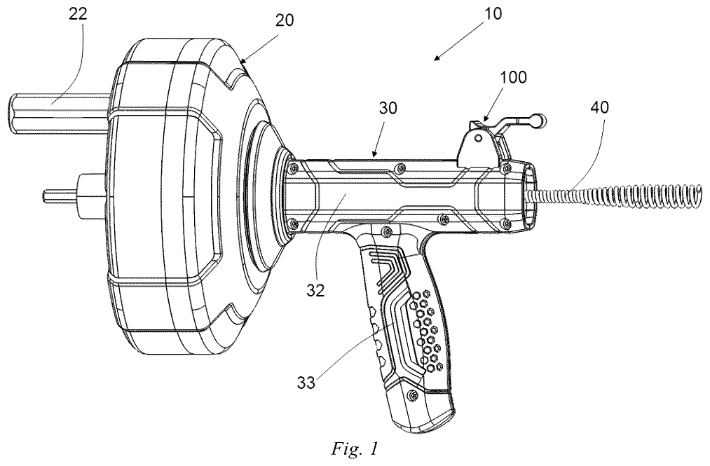

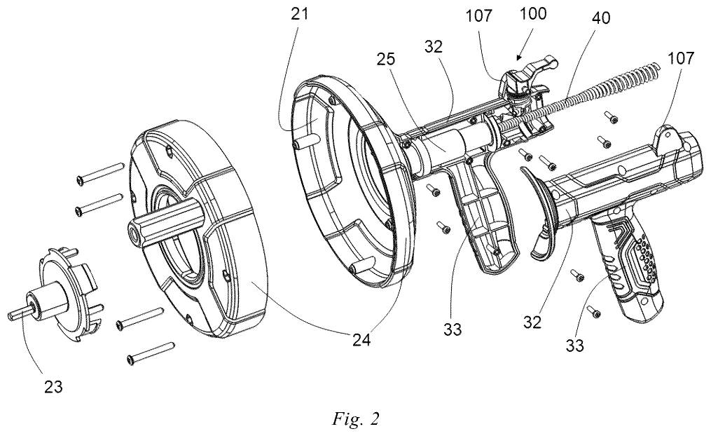

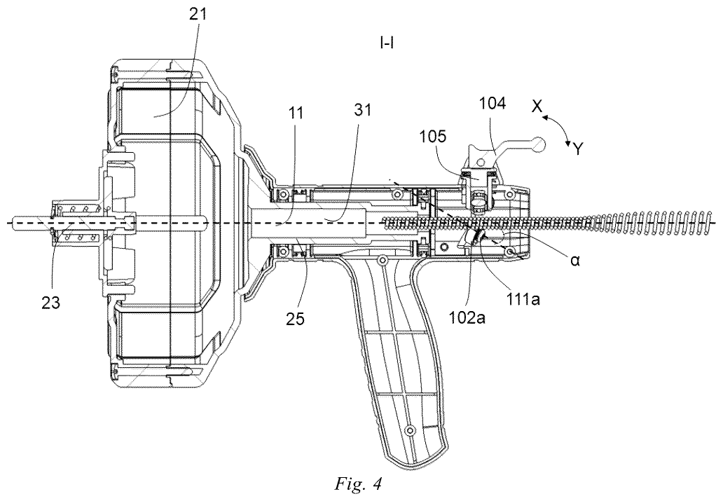

FIGS. 1 to 7 show a first embodiment. As shown in FIGS. 1 and 2, a drain clog remover 10 according to the first embodiment includes a housing component 20, a delivery component 30, an elongate, flexible shaft-like component 40 and a clamping assembly 100. The housing component 20 defines an interior hollow cavity 21 for housing the flexible shaft-like component 40. The housing component 20 is rotatably coupled to one end of the delivery component 30 in a lengthwise direction. The housing component 20 can be actuated by an external force to rotate relative to the delivery component 30. Referring to FIG. 4, the delivery component 30 defines a lengthwise extending interior channel 31 in communication with the hollow cavity 21. The flexible shaft-like component 40 can extend through the channel 31 to the outside of the delivery component 30. The clamping assembly 100 is provided on the delivery component 30 to clamp or release the flexible shaft-like component 40.

In some implementations, as shown in FIG. 1, the housing component 20 is provided with a handle 22, which can be gripped by a user and operated to actuate the housing component 20 to rotate relative to the delivery component 30. The handle 22 may be provided on an outer surface of the housing component 20 at any location suitable for operation by the user. For example, the handle 22 may be disposed on the side of the housing component 20 opposite to the delivery component 30 preferably so as to extend parallel to a center axis 11 of the housing component 20. In some implementations, an actuating shaft is provided on the housing component 20 and can be coupled to an external power source, which may be electrical, hydraulic or pneumatic. Power from the external source can be transmitted through the actuating shaft to the housing component 20 to actuate the housing component 20 to rotate relative to the delivery component 30. The actuating shaft may be provided coaxially with the center axis 11 of the housing component 20 on the side of the housing component 20 opposite to the delivery component 30. It will be understood that, as shown in FIG. 2, the handle 22 and the actuating shaft may be both provided on the housing component 20. Further, it is to be noted that the housing component 20 is not limited to being actuated using one of the two approaches as described herein, and any other approach suitable for use to actuate the housing component 20 to rotate relative to the delivery component 30 may be used within the scope of the present invention.

In some implementations, the housing component 20 includes a first shell 24, which defines the interior hollow cavity 21 for housing the flexible shaft-like component 40. The first shell 24 may be made up of two halves, and may have a circular, square or other suitable shape. The present invention is not limited to any particular shape of the first shell 24. As shown in FIGS. 2 and 4, the first shell 24 defines at one side thereof an extension 25 extending toward the delivery component 30. The extension 25 defines an interior channel 31 for passage of the flexible shaft-like component 40 therethrough. As shown in FIG. 2, the delivery component 30 surrounds the extension 25 and includes a second shell 32 optionally in an elongate, cylindrical shape. It will be understood that the present invention is not limited to any particular shape of the second shell 32. Preferably, the second shell 32 may be made up of two equal halves, which can be put together to define a space for surrounding and housing the extension 25. After the two halves are put together, fasteners may be used to secure to against each other. In some implementations, the second shell 32 may define an interior channel for passage of the flexible shaft-like component 40 therethrough, in place of that defined by the extension 25 of the first shell 24. In order to facilitate user operation, a grip 33 is provided on the delivery component 30. Preferably, the grip 33 is integrally formed with the second shell 32.

In some implementations, the flexible shaft-like component 40 is a serpentine tube optionally in the form of a tightly wound coil spring.

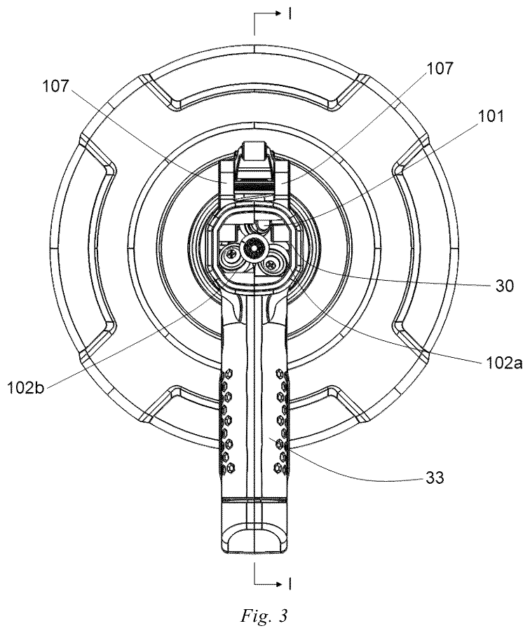

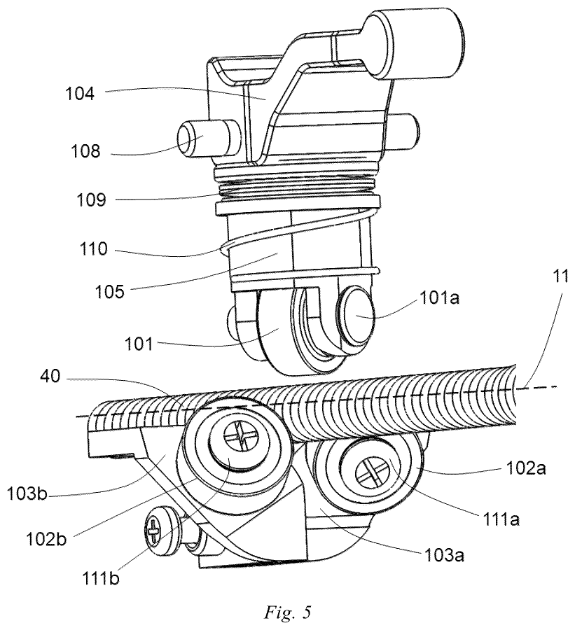

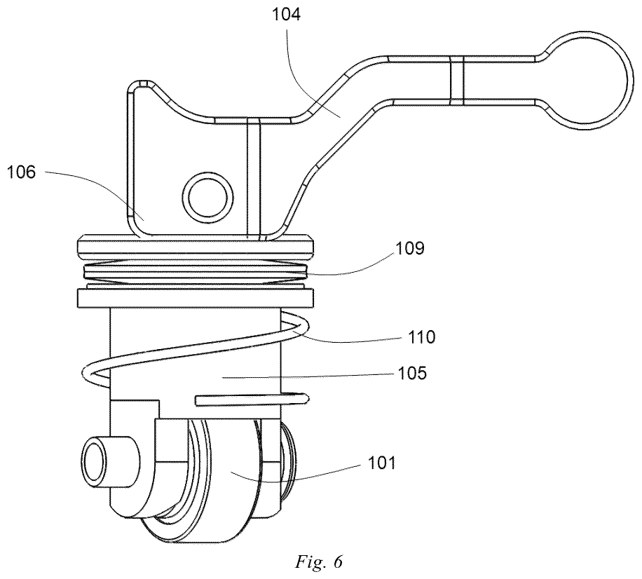

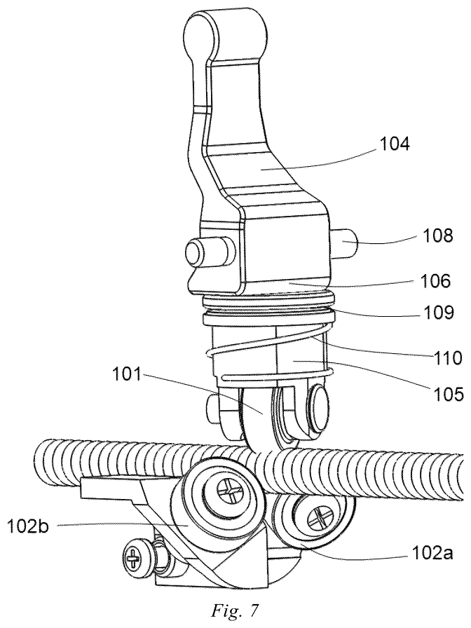

In this embodiment, as shown in FIGS. 3 and 4, the clamping assembly 100 includes one movable rolling element 101 and two fixed rolling elements 102a, 102b, all disposed within the delivery component 30. The three rolling elements are arranged circumferentially around the flexible shaft-like component 40. The fixed rolling elements 102a, 102b do not displace relative to the delivery component 30. Specifically, as shown in FIG. 5, the fixed rolling elements 102a, 102b are rotatably held on respective fixed holders 103a, 103b, which are fixedly attached to an inner side of the delivery component 30. The flexible shaft-like component 40 that is passed through the delivery component 30 remains in contact with the fixed rolling elements 102a, 102b. The movable rolling element 101 is attached to the control component 104. The control component 104 can be operated to move the movable rolling element 101 into contact with, or away from, the flexible shaft-like component 40. Specifically, the movable rolling element 101 is rotatably held on a movable holder 105, part of which protrudes out of the second shell 32 and is therefore exposed outside the second shell 32. Moreover, the movable holder 105 can slide radially with respect to the delivery component 30. As shown in FIG. 6, the control component 104 has an end portion 106 in the shape of a cam and in contact with the movable holder 105. The control component 104 is pivotably coupled to an outer side of the second shell 32. For example, referring to FIGS. 2 and 3, raised tabs 107 may be provided in opposition on the outer side of the second shell 32, and the control component 104 may be arranged between the two raised tabs 107. A pivotal shaft 108 may be passed through both raised tabs 107 so that the control component 104 can be pivoted about the pivotal shaft 108. As shown in FIG. 7, a user may apply an external force to the control component 104 to pivot it in a first direction X (see FIG. 4) so that the cam-shaped end portion 106 of the control component 104 moves downward, causing the movable holder 105 to move toward the flexible shaft-like component 40 radially with respect to the delivery component 30 until the movable rolling element 101 comes into contact with the flexible shaft-like component 40 and clamps the flexible shaft-like component 40 together with the two fixed rolling elements. At this time, the clamping assembly 100 is in a clamping state. As shown in FIG. 6, when the control component 104 is pivoted in a second direction Y under the action of an external force, the cam-shaped end portion 106 of the control component 104 will move upward and stop applying pressure to the movable holder 105. Consequently, the movable rolling element 101 releases the flexible shaft-like component 40, and the clamping assembly 100 instead assumes a non-clamping state.

In some implementations, referring to FIGS. 5 and 6, a buffer 109 is disposed between the movable holder 105 and the control component 104. In the clamping state of the clamping assembly 100, when the flexible shaft-like component 40 moves relative to the delivery component 30, the buffer 109 can tune positioning of the movable rolling element 101 relative to the flexible shaft-like component 40, thereby effectively preventing the flexible shaft-like component 40 from getting stuck. The buffer 109 is elastic, and may be implemented as, for example, a rubber pad, a resilient sheet, a spring or the like.

In some implementations, referring to FIGS. 5 and 6, a return component 110 is also provided on the movable holder 105. When the control component 104 no longer acts on the movable holder 105, the movable holder 105 will move, under the action of the return component 110, away from the flexible shaft-like component 40 radially with respect to the delivery component 30, bringing the movable rolling element 101 away from contact with the flexible shaft-like component 40. Preferably, the return component 110 may be implemented as a spring surrounding the movable holder 105.

In some implementations, the three rolling elements are obliquely disposed with respect to a center axis 11 of the flexible shaft-like component 40. Specifically, as shown in FIG. 5, each of the rolling elements is inclined relative to the flexible shaft-like component 40. An axis of rotation 101a of the movable rolling element 101 and axes of rotation 111a, 111b of the fixed rolling elements 102a, 102b each form an acute angle with the center axis 11 of the flexible shaft-like component 40. For example, as shown in FIG. 4, the axis of rotation 111a of the fixed rolling element 102a forms an acute angle α with the center axis 11. The acute angle α is preferred to be 30-60°. Preferably, the three rolling elements are inclined in different directions relative to the flexible shaft-like component 40. As shown in FIG. 5, the fixed rolling element 102b is oriented obliquely upwards with respect to the flexible shaft-like component 40, the fixed rolling element 102a is oriented obliquely downwards with respect to the flexible shaft-like component 40, and the movable rolling element 101 is oriented obliquely rearwards with respect to the flexible shaft-like component 40. When the movable rolling element 101 comes into contact with the flexible shaft-like component 40, the three rolling elements that are obliquely oriented in different directions abut against the flexible shaft-like component 40 at different angles. As the flexible shaft-like component 40 rotates, it will actuate all of the three rolling elements to rotate therewith. Consequently, the rolling elements displace relative to the flexible shaft-like component 40 along the axis thereof, extending the flexible shaft-like component 40 forward or retracting it back.

Operation of the drain clog remover 10 of this embodiment is described below.

When the control component 104 is pivoted in the first direction, the cam-shaped end portion 106 of the control component 104 urges the movable holder 105 and thereby brings the movable rolling element 101 into contact with the flexible shaft-like component 40. Consequently, the movable rolling element 101 clamps the flexible shaft-like component 40 together with the fixed rolling elements. At this time, the clamping assembly 100 is in the clamping state. The housing component 20 is then rotated by manipulating the handle 22, or by a drive device, actuating rotation of the flexible shaft-like component 40. As the rolling elements are in abutment against the flexible shaft-like component 40, they rotate to cause relative axial displacement of the flexible shaft-like component 40 relative to them. In this way, the flexible shaft-like component 40 is advanced or retracted back. In this process, the buffer 109 can tune radial positioning of the movable rolling element 101 relative to the flexible shaft-like component 40 and thereby effectively prevent bind-up of the flexible shaft-like component 40.

When the control component 104 is pivoted in the second direction, the cam-shaped end portion 106 of the control component 104 no longer urges the movable holder 105, and the movable rolling element 101 does not act on the flexible shaft-like component 40 anymore. Consequently, the rolling elements do not clamp the flexible shaft-like component 40 any longer, and the clamping assembly 100 assumes the non-clamping state. Under the action of the return component 110, the movable holder 105 and hence the movable rolling element 101 move away from the flexible shaft-like component 40. The housing component 20 is then rotated by manipulating the handle 22, or by a drive device, actuating rotation of the flexible shaft-like component 40. However, without being clamped by the rolling elements, the flexible shaft-like component 40 now rotates only and does not axially move at all, providing efficient debris cleaning.

### Example 2

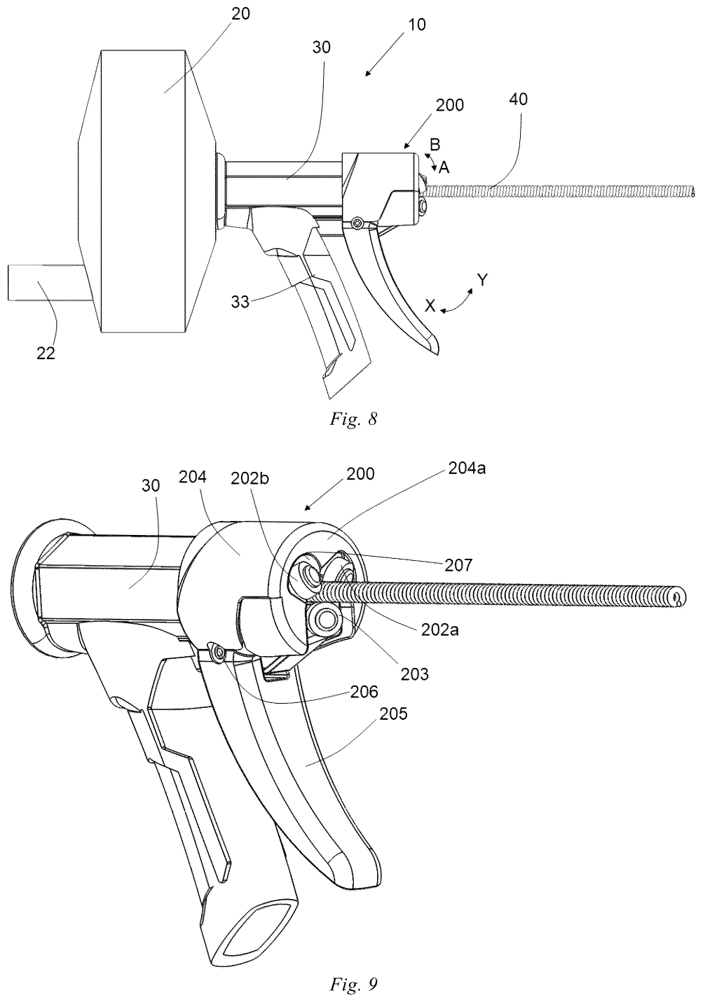

FIGS. 8 to 12 shows a second embodiment, which differs from the first embodiment in including a clamping assembly 200 of a different structure. Any common features shared between these embodiments will not be repeated, and only the clamping assembly 200 differing from that of the first embodiment will be described below.

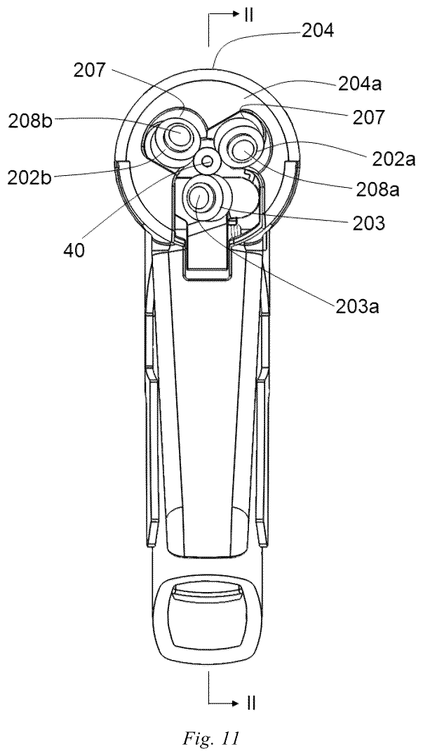

As shown in FIGS. 8, 9 and 10, the clamping assembly 200 is disposed at an end 201 of the delivery component 30 away from the housing component. The clamping assembly 200 includes two movable rolling elements 202a, 202b, one fixed rolling element 203 and a control component. The three rolling elements 202a, 202b, 203 are positioned at the end 201 of the delivery component 30 and arranged circumferentially around the flexible shaft-like component 40 (see FIG. 11). The fixed rolling element 203 is rotatably attached to the delivery component 30 and may be kept in contact with the flexible shaft-like component 40. The control component includes a ring-shaped member 204 sleeved on the delivery component 30, and the movable rolling elements 202a, 202b are rotatably attached to the ring-shaped member 204. The ring-shaped member 204 can be swung relative to the delivery component 30. As shown in FIGS. 8 and 9, the movable rolling elements are mounted to an end portion 204a of the ring-shaped member 204, which can be swung in both directions A and B. As a result of the end portion 204a of the ring-shaped member 204 being swung in the direction A toward the flexible shaft-like component 40, the movable rolling elements 202a, 202b are moved toward, and brought into abutment against, the flexible shaft-like component 40. Consequently, they clamp the flexible shaft-like component 40 together with the fixed rolling element 203, and the clamping assembly 200 assumes a clamping state, in which with similarity to the first embodiment, when the flexible shaft-like component 40 is rotated, the rolling elements 202a, 202b, 203 will be actuated to rotate, in turn causing axial displacement of the flexible shaft-like component 40 relative to the rolling elements 202a, 202b, 203. In this way, the flexible shaft-like component 40 can be pushed forward or retracted back. When the end portion 204a of the ring-shaped member 204, to which the movable rolling elements are mounted, is swung in the direction B away from the flexible shaft-like component 40, the movable rolling elements 202a, 202b will move away from contact with the flexible shaft-like component 40. As a result, the clamping assembly 200 assumes a non-clamping state, in which it does not clamp the flexible shaft-like component 40 any longer. With similarity to the first embodiment, in this configuration, the flexible shaft-like component 40 rotates only without causing its own axial movement.

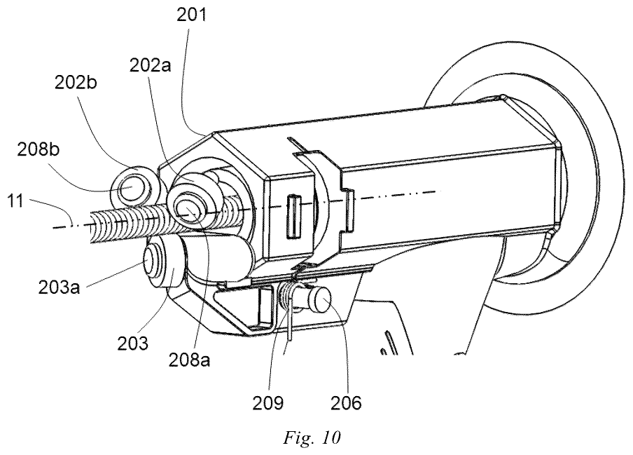

In order to facilitate the swinging of the ring-shaped member 204 for switching the clamping assembly 200 between the clamping and non-clamping states, as shown in FIG. 9, the control component further includes a control member 205, which can be operated to swing the ring-shaped member 204. Preferably, the control member 205 is shaped like a lever. One end of the lever is coupled to the ring-shaped member 204, and the other end is free. The control member 205 is attached to the delivery component by a pivotal shaft 206. When pivoted in a first direction X, the control member 205 will actuate the end portion 204a of the ring-shaped member 204 to swing in the direction A toward the flexible shaft-like component 40, placing the clamping assembly 200 into the clamping state. When the control member 205 is pivoted in a second direction Y, the end portion 204a of the ring-shaped member 204 will be swung in the direction B away from the flexible shaft-like component 40, placing the clamping assembly 200 into the non-clamping state. The control member 205 may be integrally formed with the ring-shaped member 204. Referring to FIG. 10, a return component 209 may be further provided on the control member 205. When an external force on the control member 205 is removed, the return component 209 can return the control member 205 to its original position. As required in practical applications, the original position may be such that the movable rolling elements 202a, 202b on the ring-shaped member 204 remain in abutment against the flexible shaft-like component 40, or that the movable rolling elements 202a, 202b on the ring-shaped member 204 are out of contact with the flexible shaft-like component 40. The return component 209 may be implemented as an elastic element, such as a spring, a torsion spring, a resilient sheet or the like. Preferably, in this embodiment, the return component 209 is chosen as a torsion spring, which is sleeved on the pivotal shaft 206.

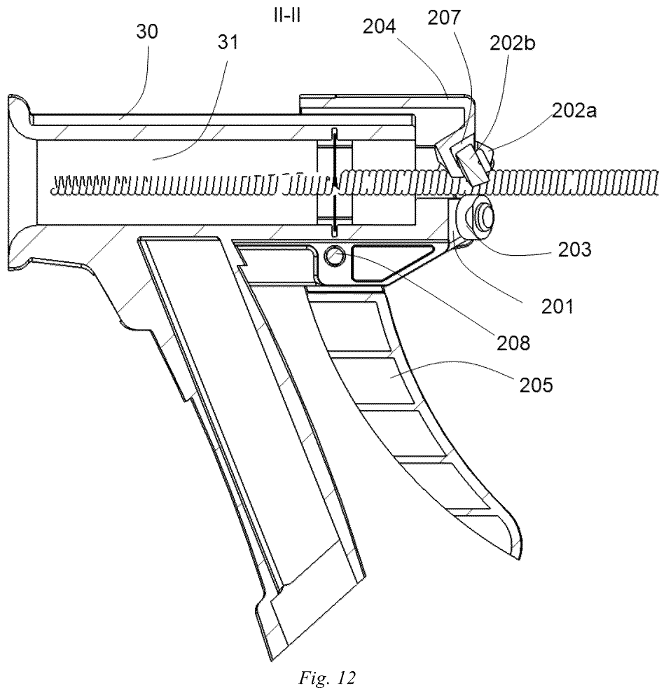

Referring to FIGS. 11 and 12, the movable rolling elements 202a, 202b may be rotatably placed in pockets 207 that the ring-shaped member 204 defines. It will be understood that any other configuration that allows the movable rolling elements 202a, 202b to be rotatably mounted to the ring-shaped member 204 can be suitably used herein.

In some implementations, referring to FIGS. 9 to 11, the three rolling elements are obliquely disposed with respect to the center axis 11 of the flexible shaft-like component 40. Specifically, each of the rolling elements is inclined relative to the flexible shaft-like component 40. Axes of rotation 208a, 208b of the movable rolling elements 202a, 202b and an axis of rotation 208 of the fixed rolling element 203 each form an acute angle with the center axis 11 of the flexible shaft-like component 40. The acute angle is preferred to be 30-60°. Preferably, the three rolling elements are inclined in different directions relative to the flexible shaft-like component 40. The movable rolling element 202b is oriented obliquely upwards with respect to the flexible shaft-like component 40, the movable rolling element 202a is oriented obliquely downwards with respect to the flexible shaft-like component 40, and the fixed rolling element 203 is oriented obliquely forwards with respect to the flexible shaft-like component 40.

### Example 3

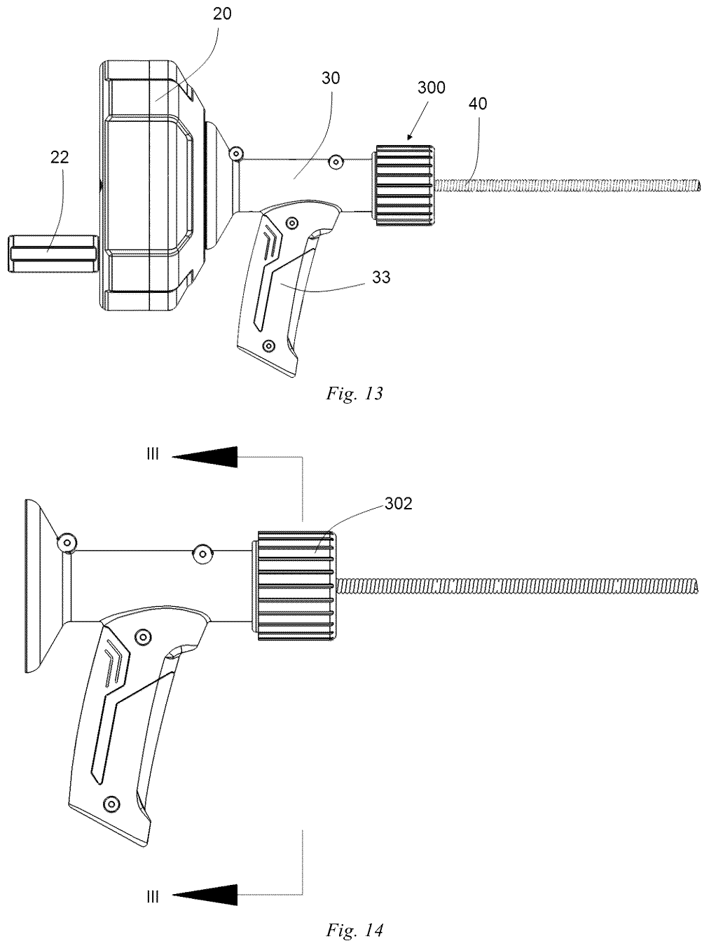

FIGS. 13 to 18 show a third embodiment, which differs from the first embodiment in including a clamping assembly 300 of a different structure. Any common features shared between these embodiments will not be repeated, and only the clamping assembly 300 differing from that of the first embodiment will be described below.

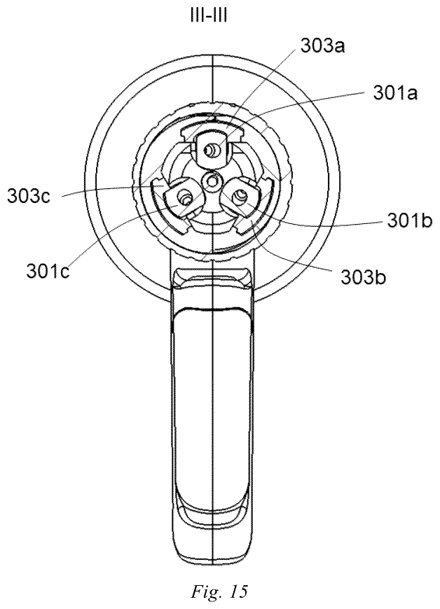

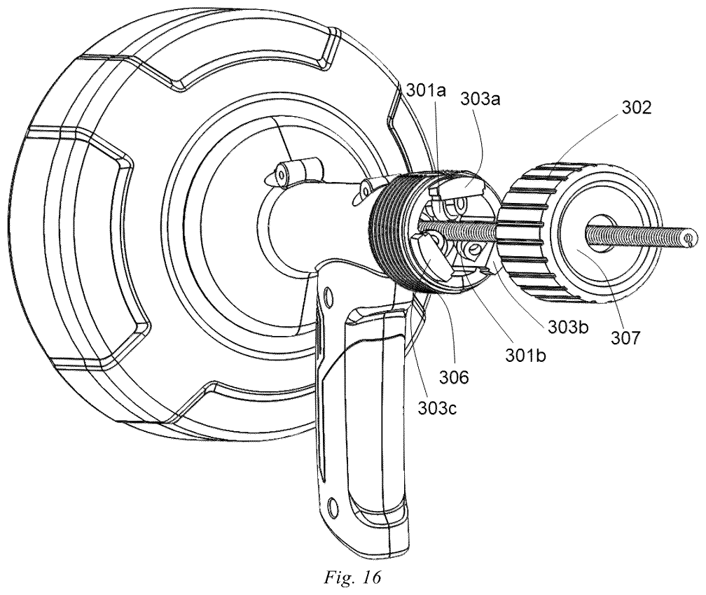

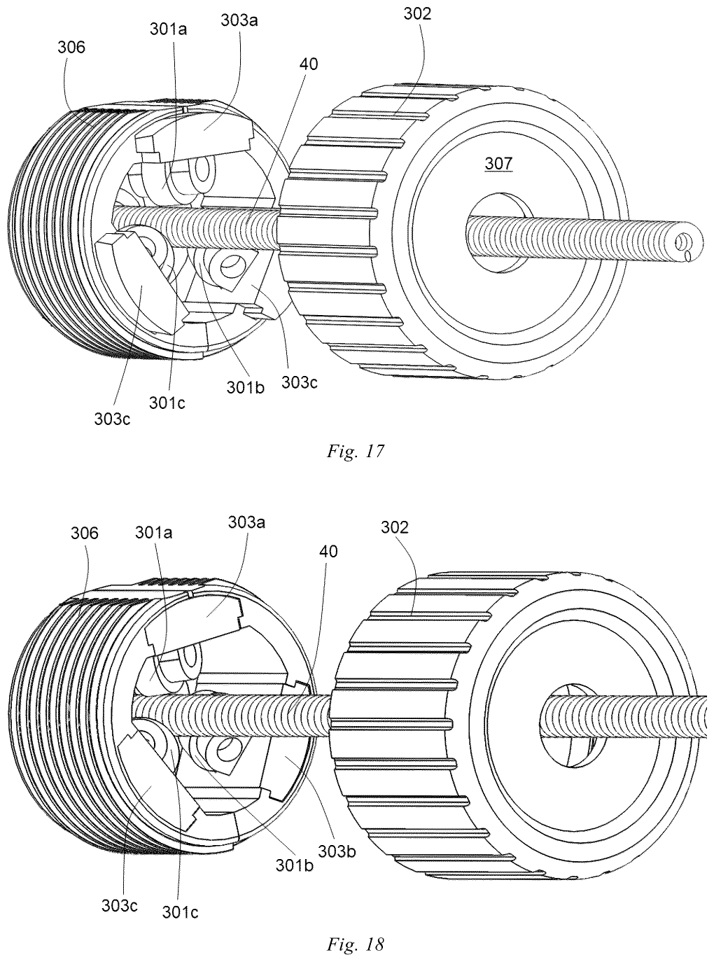

As shown in FIG. 13, the clamping assembly 300 is disposed at an end of the housing component 20 away from the delivery component 30 and includes three movable rolling elements 301a, 301b, 301c and a control component 302. The three rolling elements 301a, 301b, 301c are disposed within the delivery component 30 (see FIG. 15) and arranged circumferentially around the flexible shaft-like component 40. As shown in FIGS. 15 and 16, the rolling elements 301a, 301b, 301c are rotatably mounted to respective sliders 303a, 303b, 303c, which are disposed on an inner wall of the delivery component 30 so as to be axially slidable relative to the delivery component 30. As shown in FIG. 18, when the sliders 303a, 303b, 303c are located at a first position, the rolling elements 301a, 301b, 301c abut against and clamp the flexible shaft-like component 40. As shown in FIG. 17, when the sliders 303a, 303b, 303c are located at a second position, the rolling elements 301a, 301b, 301c do not contact or clamp the flexible shaft-like component 40.

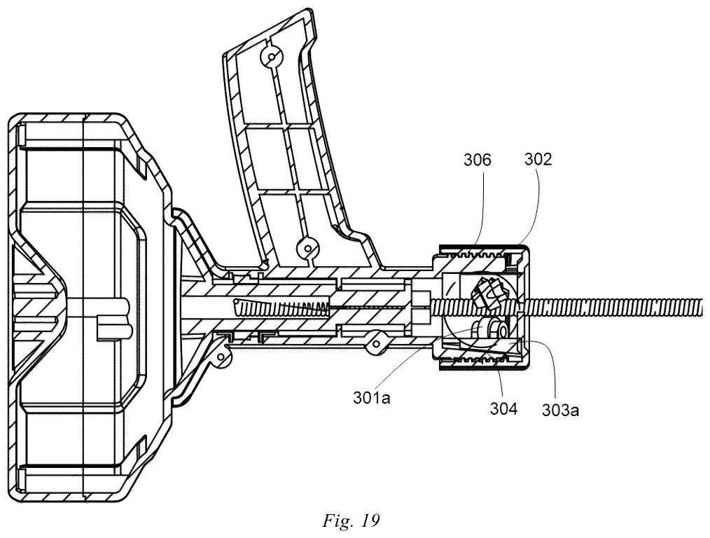

The sliders 303a, 303b, 303c are attached to the delivery component 30 in the same way, and only the slider 303a is described herein. As shown in FIG. 19, the slider 303a contacts the delivery component 30 at a surface 304 thereof, which is slanted with respect to the axis of the flexible shaft-like component 40. Due to the presence of the slanted surface 304, the three sliders 303a, 303b, 303c, and hence the three rolling elements 301a, 301b, 301c, are spaced from the flexible shaft-like component 40 at different radial distances at the first and second positions. Accordingly, they clamp the flexible shaft-like component 40 and not, when at the different positions. Preferably, the sliders 303a, 303b, 303c are embedded in a side wall of the delivery component 30.

The control component 302 is used to control the sliders 303 to switch it between the different positions. In some implementations, as shown in FIG. 16, a thread 306 is provided in an outer wall of the delivery component 30 at an end thereof away from the housing component 20. The control component 302 is implemented as a cylindrical component, which is fitted over the delivery component 30 in such a manner that an inner side of the cylindrical component engages the thread 306. Rotating the cylindrical component can cause its axial movement. A side wall 307 of the cylindrical component on an axial side thereof is attached to ends of the sliders 303a, 303b, 303c. When the cylindrical component is moved toward the housing component 20 along the thread 306, the sliders 303a, 303b, 303c will be actuated to move toward the slanted surface 304. Consequently, the rolling elements 301a, 301b, 301c are gathered inwardly and clamp the flexible shaft-like component 40, placing the clamping assembly 300 into a clamping state. When the cylindrical component is moved away from the housing component 20, the rolling elements 301a, 301b, 301c will be separated from the flexible shaft-like component 40, placing the clamping assembly 300 into a non-clamping state. It will be understood that the control component 302 is not limited to being implemented as a cylindrical component engageable with the thread 306, and any other implementation of the control component 302 that can actuate movement of the sliders 303 can also be suitably used herein.

With similarity with the first and second embodiments, the three rolling elements 301a, 301b, 301c are obliquely disposed with respect to the center axis 11 of the flexible shaft-like component 40. Each rolling element is oriented at an acute angle with respect to the center axis of the flexible shaft-like component 40. The acute angle is preferred to be 30-60°. Preferably, the three rolling elements 301a, 301b, 301c are inclined in different directions relative to the flexible shaft-like component 40.

Although the clamping assemblies of the three embodiments have been described above as each including three rolling elements, it will be appreciated that the present invention is not limited to any particular number of rolling elements. As required in practical applications, two or more than three rolling elements may be included.

Although a few preferred specific embodiments of the present application have been described in detail above, it will understood that those of ordinary skill in the art can make various modifications and changes thereto based on the concept of the present application without exerting any creative effort. Accordingly, all variant embodiments that can be obtained by those skilled in the art through logical analysis, inference or limited experimentation in accordance with the concept of the present invention on the basis of the prior art are intended to fall within the scope as defined by the appended claims.

1. A drain clog remover, comprising:
an elongate, flexible shaft-like component;
a housing component defining a hollow cavity therein for housing the flexible shaft-like component;
a delivery component coupled at one end thereof to the housing component, the housing component configured to be rotatable relative to the delivery component, the delivery component defining a channel therein for passage of the flexible shaft-like component therethrough, the channel in communication with the hollow cavity, wherein the housing component, when rotated, actuates the flexible shaft-like component to rotate; and
a clamping assembly disposed on the delivery component, the clamping assembly having a first state and a second state, wherein in the first state, the clamping assembly clamps the flexible shaft-like component so that the flexible shaft-like component, when rotated, displaces axially; and in the second state, the clamping assembly releases the flexible shaft-like component so that the flexible shaft-like component, when rotated, does not displace axially.

2. The drain clog remover of claim 1, wherein the clamping assembly comprises a plurality of rolling elements arranged circumferentially around the flexible shaft-like component, wherein the plurality of rolling elements includes at least one movable rolling element, wherein in the first state, the movable rolling element is in contact with the flexible shaft-like component, and in the second state, the movable rolling element is out of contact with the flexible shaft-like component.

3. The drain clog remover of claim 2, wherein the clamping assembly further comprises a control component configured to actuate, under the action of an external force, the movable rolling element to move into or out of contact with the flexible shaft-like component.

4. The drain clog remover of claim 3, wherein the delivery component is provided on its side wall with a movable holder configured to move in a radial direction of the delivery component driven by an external force; the movable rolling element is rotatably coupled to one end of the movable holder; and the other end of the movable holder is coupled to the control component.

5. The drain clog remover of claim 4, wherein the control component is pivotably coupled to the delivery component, has a cam-shaped end portion and is configured to be actuatable by an external force to pivot in a first direction so that the cam-shaped end portion actuates the movable holder to move toward the flexible shaft-like component to bring the movable rolling element into contact with the flexible shaft-like component and to pivot in a second direction so that the cam-shaped end portion releases the movable holder to allow the movable rolling element to move out of contact with the flexible shaft-like component.

6. The drain clog remover of claim 4, wherein the plurality of rolling elements further includes a fixed rolling element rotatably coupled to a fixed holder fixedly coupled to the delivery component.

7. The drain clog remover of claim 5, wherein a buffer is disposed between the control component and the movable holder.

8. The drain clog remover of claim 5, wherein the movable holder is provided with a return component configured to actuate, after a force applied by the control component to the movable holder is removed, the movable holder to move to its original position.

9. The drain clog remover of claim 3, wherein the control component comprises a ring-shaped member sleeved on the delivery component at an end thereof away from the housing component, the movable rolling element is rotatably coupled to the ring-shaped member, and the ring-shaped member is configured to be swingable relative to the delivery component.

10. The drain clog remover of claim 9, wherein the plurality of rolling elements further includes a fixed rolling element rotatably coupled to the delivery component, and the movable rolling element is disposed at an end of the ring-shaped member which is actuatable by an external force to swing relative to the delivery component.

11. The drain clog remover of claim 10, wherein the control component further comprises a control member pivotably coupled to the delivery component, wherein one end of the control member is coupled to the ring-shaped member, and the control member is configured to be actuatable by an external force to pivot relative to the delivery component and thereby actuate the ring-shaped member to swing.

12. The drain clog remover of claim 11, wherein the control member is provided with a return component configured to actuate, after a force applied to the control member is removed, the control member to return to its original position.

13. The drain clog remover of claim 3, wherein a thread is provided in a side wall of the delivery component at an end thereof away from the housing component, and the control component comprises a cylindrical component sleeved on the delivery component and engaged with the thread.

14. The drain clog remover of claim 13, wherein the movable rolling element is rotatably disposed on a slider slidably coupled to an inner wall of the delivery component.

15. The drain clog remover of claim 14, wherein a surface between the slider and the delivery component is slanted with respect to an axis of the delivery component.

16. The drain clog remover of claim 15, wherein the cylindrical component is configured to actuate, when rotated relative to the delivery component, the slider to slide along an axis of the delivery component.

17. The drain clog remover of claim 2, wherein an axis of rotation of each of the plurality of rolling elements forms an acute angle with a center axis of the flexible shaft-like component.

18. The drain clog remover of claim 17, wherein each of the plurality of rolling elements is inclined in a different direction with respect to the flexible shaft-like component.

19. The drain clog remover of claim 1, wherein the housing component is provided with an actuator for actuating the housing component to rotate relative to the delivery component.

20. The drain clog remover of claim 19, wherein the actuator comprises a handle eccentrically disposed with respect to a center axis of the housing component and/or a driving shaft disposed coaxially with the center axis of the housing component.
